(19) United States
(12) Patent Application Publication
(10) Pub. No.: US 2024/0347906 A1
(43) Pub. Date: Oct. 17, 2024

(54) FULL ANALOG PHASE SHIFTER AND ANTENNA APPARATUS INCLUDING SAME

(71) Applicant: KMW INC., Hwaseong-si (KR)

(72) Inventors: Duk Yong KIM, Yongin-si (KR); Young Chan MOON, Suwon-si (KR); Seong Man KANG, Hwaseong-si (KR); Sung Hwan SO, Hwaseong-si (KR); Chi Back RYU, Hwaseong-si (KR); Kyo Sung JI, Hwaseong-si (KR); Oh Seog CHOI, Hwaseong-si (KR); Dong Hee SHIN, Incheon (KR); Won Jun PARK, Yongin-si (KR); Yong Won SEO, Daejeon (KR)

(73) Assignee: KMW INC., Hwaseong-si (KR)

(21) Appl. No.: 18/757,533

(22) Filed: Jun. 28, 2024

Related U.S. Application Data
(63) Continuation of application No. PCT/KR2022/021685, filed on Dec. 30, 2022.

(30) Foreign Application Priority Data
Dec. 30, 2021 (KR) 10-2021-0193283
Jan. 3, 2022 (KR) 10-2022-0000544
Dec. 29, 2022 (KR) 10-2022-0188117

(51) Int. Cl. H01Q 3/32; H01Q 21/06

(52) U.S. Cl. CPC H01Q 3/32; H01Q 21/062; H01Q 21/065

(57) ABSTRACT

The present invention relates to a full analog phase shifter and an antenna apparatus including same, and more particularly, comprises: a variable switch panel including a first conductive pattern terminal and a second conductive pattern terminal; and an antenna element substrate on which a plurality of array antenna elements are arranged and a transmission line being in contact with the first conductive pattern terminal and the second conductive pattern terminal is pattern-printed, wherein, due to a phase shift caused by contact points of the transmission line with respect to the first conductive pattern terminal and the second conductive pattern terminal, phases of the plurality of antenna elements are linearly array distributed on a same reference phase plane, thereby providing an advantage of easily implementing a mirror symmetry structure having a linear phase distribution only by a phase shift in an RF stage without phase conversion in a digital stage.

### TECHNICAL FIELD

The present disclosure relates to a full analog phase shifter and an antenna apparatus including the same, and more particularly, to a full analog phase shifter which includes a full analog phase shifter in an RF stage and can secure a desired phase shift value by selectively changing the lengths of all of transmission lines, without a change in the arrangement and design of the existing RF module and also a need for a separate installation space design, and an antenna apparatus including the same.

### BACKGROUND ART

In domestic and foreign mobile communication systems, subscribers' usage density is changed for each region and time zone. In order to provide optimal services in such a situation, network management in which coverage of a base station is adjusted by adjusting the angle of a vertical beam of a base station antenna is performed.

To this end, a mechanical beam tilt method is used in a conventional wireless communication system. Such a mechanical beam tilt method is a method of directly adjusting the direction of a radiant beam of an antenna by adjusting the angle of the antenna by using a mechanical beam tilt apparatus mounted on the antenna.

An advantage of the mechanical beam tilt method is to be capable of lowering a production cost of the antenna. However, the mechanical beam tilt method has a danger, such as a fall, and has low rapidness in repair due to a lot of time taken, because a technician has to perform a complicated process of directly climbing a base station antenna tower, loosening several bolts that fix a beam tilt instrument, changing the angle of an antenna, and then fastening the bolts again for a base station operation.

In order to supplement the disadvantages of the mechanical beam tilt method, a mechanical beam tilt apparatus using a remote adjustment method capable of adjusting the tilting or steering of the mechanical beam tilt apparatus at a remote place is recently developed.

However, the mechanical beam tilt apparatus using the remote adjustment method adjusts the direction of an antenna radiant beam by an operation of mechanically adjusting the tilting or steering of the entire antenna, and uses an antenna radiant beam adjustment method that is basically different from an electrical beam tilt method. An electrical beam tilt antenna includes a phase shifter for adjusting the phase of a beam therein.

FIG. 1 is a physical phase shift principle using a phase shifter. FIG. 2 is a circuit diagram and phase difference diagram for describing the principle of a phase shift form that is performed in an RF stage.

Referring to FIG. 1, when the physical length of a transmission line through which a feed signal passes is changed, the phase of the feed signal is changed by a physical length variance ΔL. If a phase difference is implemented in an RF stage by using such a principle, a phase shift (off-set support task) in a digital stage is accompanied as illustrated in FIG. 2.

Specifically, as illustrated in FIG. 2, if a phase difference is applied to one of two output stages that are branched off from the RF stage by ΔΦ, there is a problem in that the implementation of a uniform phase difference for a desired phase surface, that is, an off-set support task, needs to be generally performed on one of two input stages by −2ΔΦ in order to achieve a linear phase distribution.

Furthermore, in order to implement a phase difference at the RF stage, there is a problem in that the front and rear thickness of an antenna is increased because a space in which a physical switching structure (phase shifter) will be constructed is essentially required between an RF filter and an array antenna element.

### DISCLOSURE

### Technical Problem

The present disclosure has been invented to solve the above technical problems, and has an object of providing a full analog phase shifter capable of implementing a linear phase distribution of a mirror symmetry structure by only a phase shift in an RF stage without a phase shift in a digital stage, and an antenna apparatus including the same.

Furthermore, another object of the present disclosure is to provide a full analog phase shifter capable of optimizing the implementation of product slimness by preventing a front and rear thickness part from increasing by minimizing the assignment of a space for installing a full analog phase shifter, and an antenna apparatus including the same.

Objects of the present disclosure are not limited to the aforementioned objects, and the other objects not described above may be evidently understood from the following description by those skilled in the art.

### Technical Solution

A full analog phase shifter according to an embodiment of the present disclosure includes a variable switch panel including a first conduction pattern terminal and a second conduction pattern terminal, and an antenna element board in which multiple array antenna elements are disposed and on which a transmission line with which the first conduction pattern terminal and the second conduction pattern terminal come into contact has been pattern-printed. Phases for the multiple array antenna elements form a linear distribution on a same reference phase surface by a phase shift at the contact point of the first conduction pattern terminal and the second conduction pattern terminal, and the transmission line.

Furthermore, the lengths of one side-transmission line and other side-transmission line of the antenna element board may have a predetermined ratio.

Furthermore, the ratio of lengths of two output stages that come into contact with an inside variable circuit before being branched off from each of two input stages to two output stages and an outside variable circuit after the branch off and that are related to each of the two input stages may be the predetermined ratio.

In this case, the predetermined ratio may be 1:3.

Furthermore, the inside variable circuit and the outside variable circuit may each be pattern-printed to have a first power-off point and a second power-off point in each of which a part of the transmission line is disconnected. A first conduction pattern terminal of the variable switch panel may conduct the first power-off point corresponding to the inside variable circuit. A second conduction pattern terminal of the variable switch panel may conduct the second power-off point corresponding to the outside variable circuit.

Furthermore, a first output stage and a third output stage that are branched off from a first input stage, among the two input stages, may be arranged to be spaced apart from each other in a vertical direction (a V-direction) on a left side of the antenna element board. A second output stage and a fourth output stage that are branched off from a second input stage, among the two input stages, may be arranged to be spaced apart from each other in the vertical direction on a right side of the antenna element board. On the premises that two antenna element boards are arranged in the vertical direction, two variable switch panels may also be provided to be simultaneously driven. A vertical phase difference in each output stage by the simultaneous driving of the two variable switch panels may have a straight-line gradient distribution with respect to the same reference phase surface.

Furthermore, the two variable switch panels may each be provided in a rotator type in which the variable switch panel is rotated around a front and rear horizontal axis on a front surface of the inside variable circuit and the outside variable circuit including the first power-off point and the second power-off point.

Furthermore, the two variable switch panels each having the rotator type may be provided to rotate in opposite directions, on the premise that the first power-off point and the second power-off point pattern-printed on the two antenna element boards are identical with each other.

Furthermore, the two variable switch panels may each be provided in a slider type in which the variable switch panel slides in the vertical direction on a front surface of the first power-off point and the second power-off point.

Furthermore, the two variable switch panels each having the slider type may be provided to simultaneously slide in an identical direction, on the premise that all of transmission lines including the first power-off point and the second power-off point that are pattern-printed on the two antenna element boards are symmetrical to each other.

Furthermore, when a first beam output part between the first output stage and the second output stage that are provided in an antenna element board on an upper side in the vertical direction, among the two antenna element boards, is defined and a second beam output part between the third output stage and the fourth output stage that are provided in the antenna element board on the upper side is defined, and a third beam output part between the first output stage and the second output stage that are provided on an antenna element board on a lower side in the vertical direction, among the two antenna element boards, is defined and a fourth beam output part between the third output stage and the fourth output stage that are provided on the antenna element board on the lower side is defined, by the simultaneous driving of the two variable switch panels, each of the second beam output part and the third beam output part may change the length of the transmission line into a length in which the transmission line is shifted by ±ΔΦ with respect to the same reference phase surface, and each of the first beam output part and the fourth beam output part may change the length of the transmission line into a length in which the transmission line is shifted by +Δ3Φ with respect to the same reference phase surface.

An antenna apparatus according to an embodiment of the present disclosure includes a unit RF filter body configured to form a predetermined front and rear thickness part on a front surface of a main board, stacked and arranged to be electrically connected to the main board, and configured to have, on a front surface thereof, a reflector panel that performs a ground (GND) function integrally extended and formed in up and down and left and right directions in an area greater than an area of the front surface, a radiation element module stacked and disposed on the front surface of the reflector panel and including, on a front surface thereof, an antenna element board in which four array antenna elements are disposed to be spaced apart from each other in the up and down directions, and a full analog phase shifter (hereinafter abbreviated as a “phase shifter”) including multiple variable switch panels that change a length of a transmission line by an operation of rotating in a separation space formed between the four array antenna elements and the antenna element board.

In this case, the separation space may be defined between a rear surface of the four array antenna elements and a front surface of the antenna element board.

Furthermore, the phase shifter may further include a phase shift driving motor disposed in the front and rear thickness part of the unit RF filter body on a rear side of the antenna element board, a horizontal mounting bar moved in the up and down directions by a driving force of the phase shift driving motor, and multiple vertical mounting bars each having one end connected to the horizontal mounting bar and the other end vertically extended upward or downward and connected to each of the multiple variable switch panels.

Furthermore, a hinge coupling protrusion formed on a front surface of the horizontal mounting bar may be hinged and coupled to any one, among one end and the other end of the vertical mounting bar.

Furthermore, a hinge pin hinged and coupled to the variable switch panel through the reflector panel formed to be wider than a front surface of the unit RF filter body and the antenna element board is formed at the other one, among one end and the other end of the vertical mounting bar.

Furthermore, an arc type guide slot that provides guidance to an arc movement of the hinge pin of the vertical mounting bar may be formed in the reflector panel and the antenna element board so that the guide slot penetrates the reflector panel and the antenna element board in forward and backward directions.

Furthermore, a screw rod having a male screw thread formed on an outer circumferential surface thereof and extended in a predetermined length in a direction of a rotation axis of the phase shift driving motor may be provided in the rotation axis. The phase shifter may further include an up and down moving block in which a rod through part through which the screw rod penetrates in the up and down directions is formed and an arm screw thread fastened to the male screw thread is formed in the rod through part, and which are moved in the up and down directions in response to a rotation direction of the screw rod, and a block guide part configured to provide guidance to the up and down movement of the up and down moving block.

Furthermore, the horizontal mounting bar may be hook-coupled to a front of the up and down moving block.

Furthermore, the phase shifter may further include a horizontal bracket part left and right horizontally disposed within an antenna housing part in which a main board is installed so that the block guide part is fixed. Bearing wheels rotatably supported within a left support panel and a right support panel provided at both ends of the horizontal bracket part may be provided at both ends of the horizontal mounting bar, respectively.

Furthermore, the antenna apparatus may further include at least one fixing bridge bar for fixing the unit RF filter body to an internal space of the antenna housing part. The horizontal bracket part may be fixed to the internal space of the antenna housing part in order to substitute any one of the fixing bridge bars.

Furthermore, the antenna apparatus may further include at least one fixing bridge bar for fixing the unit RF filter body to an internal space of the antenna housing part. The horizontal bracket part may be fixed to the internal space of the antenna housing part through a medium of any one of the fixing bridge bars.

Furthermore, the fixing bridge bar may be left and right horizontally extended and formed in each of a top portion, bottom portion, and middle portion of the internal space of the antenna housing part. The horizontal bracket part may substitute a fixing bridge bar formed in the middle portion.

Furthermore, the fixing bridge bar may be left and right horizontally extended and formed in each of a top portion, bottom portion, and middle portion of the internal space of the antenna housing part. The horizontal bracket part may be fixed through the medium of the fixing bridge bar formed in the middle portion.

Furthermore, assuming that two unit RF filter bodies are arranged in the internal space of the antenna housing part in up and down vertical directions (V-direction), the horizontal bracket part that substitutes the fixing bridge bar constructed in the middle portion may be provided in a space between the two unit RF filter bodies in the up and down directions.

Furthermore, multiple screw fastening holes for a screw assembly with the unit RF filter body may be formed in the fixing bridge bar or the horizontal bracket part that substitutes the fixing bridge bar.

Furthermore, the vertical mounting bar may be provided to correspond to the number of unit RF filter bodies.

Furthermore, the antenna apparatus according to an embodiment of the present disclosure includes the aforementioned full analog phase shifter.

### Advantageous Effects

The antenna apparatus according to embodiments of the present disclosure has effects in that it is possible to prevent the front and rear thickness of a product from increasing because a space between the unit RF filter body and the printed circuit board for a radiation element does not need to be spaced apart from each other in order to install the phase shifter and it is possible to reduce the number of parts because a phase shift for all of multiple RF modules is possible by the driving force of one phase shift driving motor.

Furthermore, the antenna apparatus according to embodiments of the present disclosure has an effect in that a phase difference of the mirror symmetry structure can be implemented even without requiring a support task in a digital stage.

### DESCRIPTION OF DRAWINGS

FIG. 1 is a graph that describes the principle of a phase shift.

FIG. 2 is a circuit diagram and phase difference diagram for describing the principle of a phase shift form that is performed in an RF stage.

FIG. 3 is a perspective view illustrating an antenna apparatus according to an embodiment of the present disclosure.

FIGS. 4A and 4B are exploded perspective views of a front part and rear part of the antenna apparatus of FIG. 3.

FIG. 5 is a front view and rear view illustrating an operation form of a phase shifter, among components of an embodiment of the present disclosure.

FIG. 6 is an enlarged and exploded perspective view of a part “D” in FIG. 5.

FIG. 7 is an exploded perspective view illustrating the state in which a radome panel, among the components of FIG. 3, has been separated.

FIGS. 8A and 8B are exploded perspective views of the front part and the rear part in which the phase shifter, among the components of FIG. 3, has been exposed to the outside.

FIGS. 9A and 9B are diagrams illustrating the phase shifter, among the components of FIG. 3, and are exploded perspective views of the front part and the rear part in the state in which the radome panel and an antenna housing part have been removed.

FIG. 10 is an exploded perspective view illustrating an installation form of the phase shifter for the antenna housing part.

FIG. 11 is an exploded perspective view of a part of the phase shifter fixed to a middle portion of the antenna housing part, among the components of FIG. 10.

FIG. 12 is an exploded perspective view illustrating a fixed form of a unit RF module for a fixing bridge bar that is fixed to a top portion of the antenna housing part, among the components of FIG. 10.

FIGS. 13 and 14 are a cross-sectional view and incisional perspective view illustrating the phase shifter, among the components of FIG. 3, and a partial enlargement view thereof.

FIGS. 15A and 15B are exploded perspective views of the front part and the rear part illustrating the arrangement relation of the phase shifter centering around an antenna element board, among the components of FIG. 3.

FIG. 16 is an exploded perspective view of the front part and the rear part for describing a switching operation form of a variable switch panel for the antenna element board, among the components of FIG. 3.

FIG. 17 is a front view of the antenna element board illustrating a contact point change of a transmission line pattern form in a first embodiment for the implementation of a phase difference of a mirror symmetry structure and a partial enlargement view thereof.

FIG. 18 is a front view of the antenna element board illustrating a transmission line pattern form in a second embodiment for the implementation of a phase difference of the mirror symmetry structure.

FIG. 19 is a circuit diagram and phase difference diagram for describing the principle of a phase shift form that is performed in an RF stage using the phase shifter of the antenna apparatus according to an embodiment of the present disclosure.

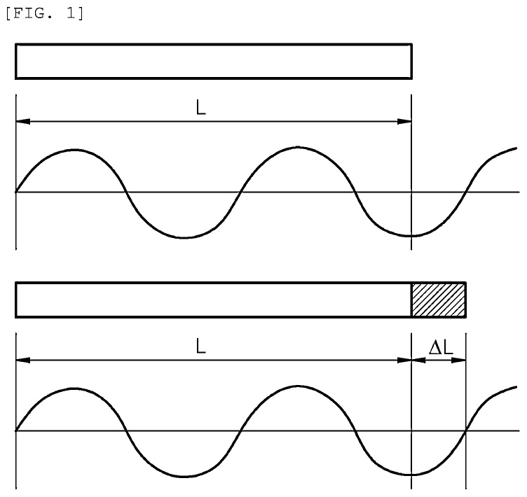

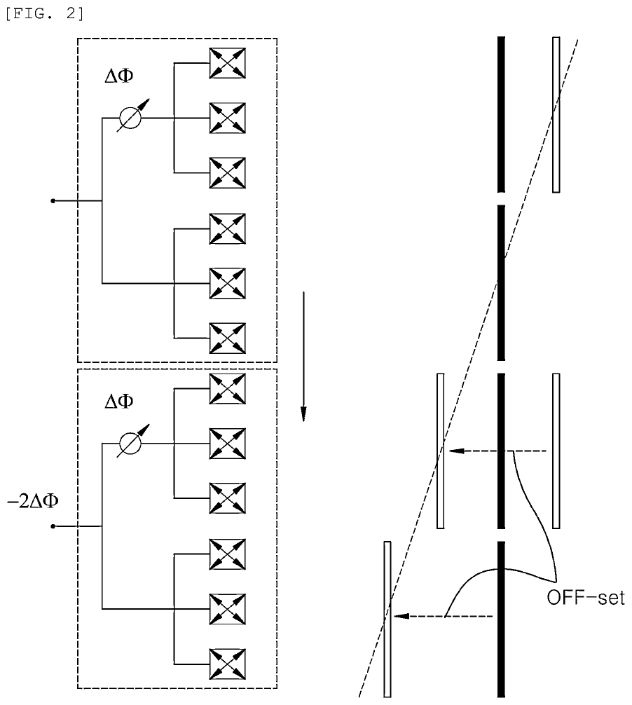

<Description of reference numerals>

| | |
|---|---|
| 100: antenna apparatus | 110: antenna housing part |
| 120: main board | 130: PSU board part |
| 140: surge board part | 200: RF module |
| 210: RF filter | 211: unit RF filter body |
| 220: amplification element part | 230: radiation element module |
| 231: antenna element board | 231a: rotation hole |
| 231b: cover coupling hole | 231c: guide slit |
| 232a: one side-transmission line | 232b: other side-transmission line |
| 233: power feeding base | 234a: first input stage |
| 234b: second input stage | 235: array antenna element |
| 236a: first output stage | 236b: second output stage |
| 236c: third output stage | 236d: fourth output stage |
| 247a: first power-off point | 247b: second power-off point |
| 300: radome panel | 400: external mounting member |
| 500: phase shifter | 510: phase shift driving motor |
| 520: horizontal mounting bar | 530: vertical mounting bar |
| 540: variable switch panel | 547a: first conduction pattern |
| | terminal |
| 547b: second conduction pattern | 550: rotator cover |
| terminal | |
| 560: horizontal bracket part | 570: elastic member |

### BEST MODE

Hereinafter, an antenna apparatus according to an embodiment of the present disclosure is described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively: formal meanings unless explicitly defined otherwise in the specification.

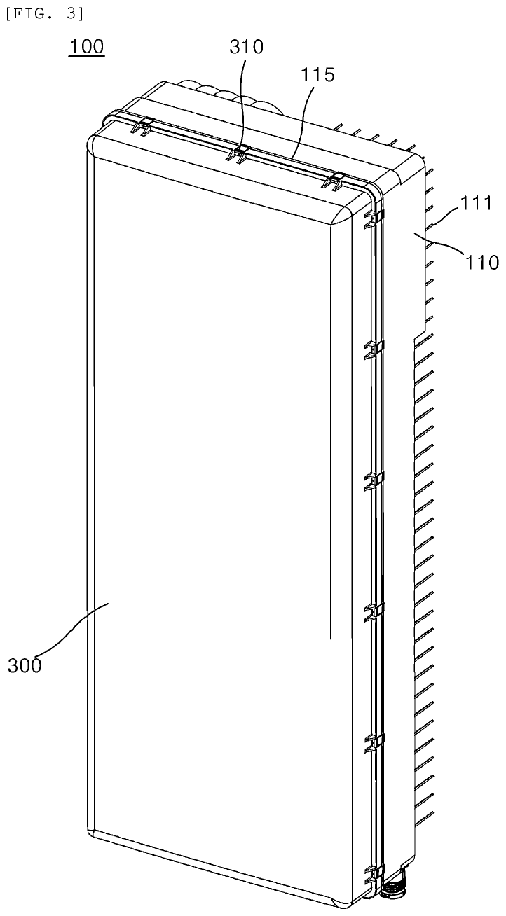

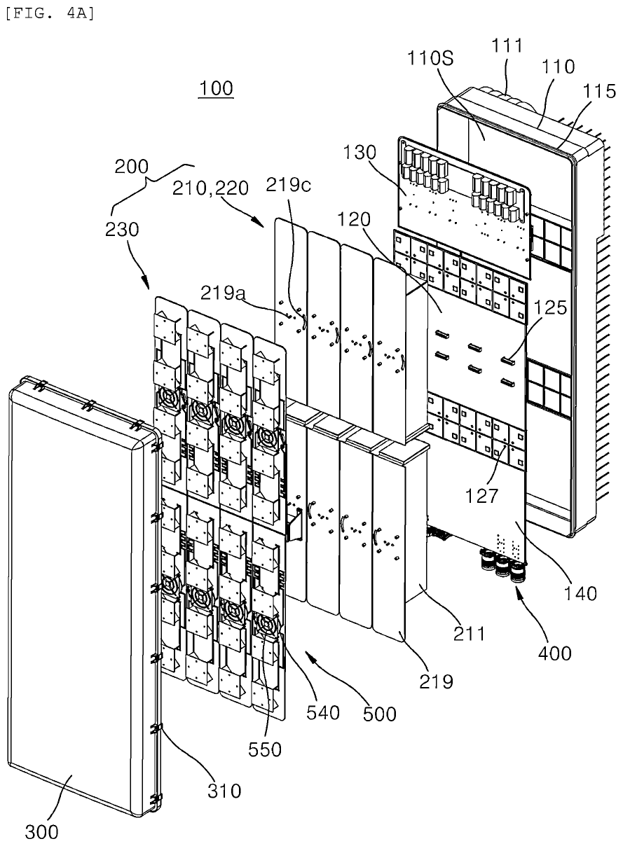

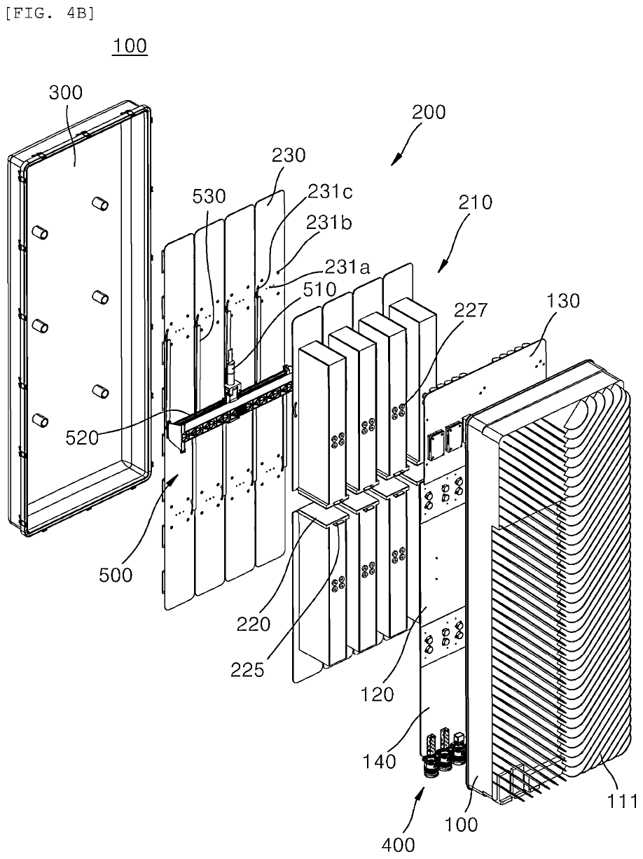

FIG. 3 is a perspective view illustrating an antenna apparatus according to an embodiment of the present disclosure. FIGS. 4A and 4B are exploded perspective views of a front part and rear part of the antenna apparatus of FIG. 3.

An antenna apparatus 100 according to an embodiment of the present disclosure may be an antenna apparatus into which a massive multiple input multiple output (MIMO) technology has been incorporated.

In this case, the MIMO technology is a technology in which a data transmission capacity is significantly increased by using multiple array antenna elements, and is a spatial multiplexing scheme in which a transmitter transmits different data through transmission antennas and a receiver identifies the transmission data through proper signal processing. Accordingly, more data can be transmitted because a channel capacity is increased by simultaneously increasing the numbers of transmission and reception antennas. For example, if the number of antennas is increased to 10, a channel capacity that is about 10 times is secured compared to a single antenna system by using the same frequency band.

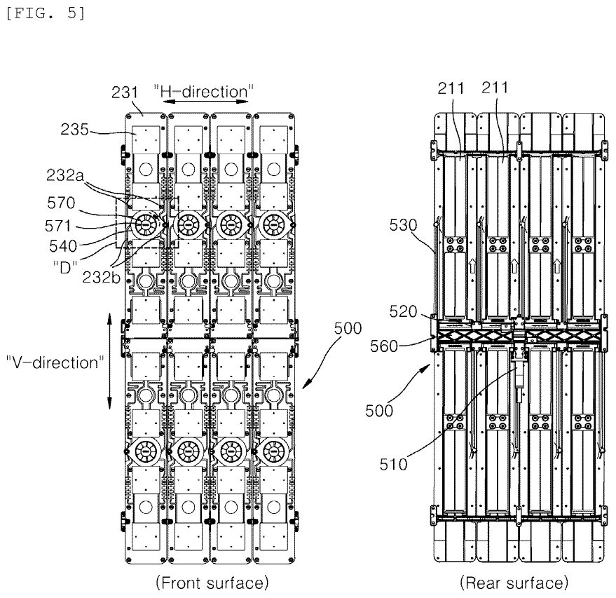

In particular, as referred in FIG. 5, multiple array antenna elements 235 that each up and down vertically (V)-left and right horizontally (H) arrange a TRx module (not illustrated) that performs a transmitter and receiver function in up and down vertical directions (V-direction) and a left and right horizontal direction (H-direction) and that are electrically connected to the TRx modules, respectively, may be arranged in the antenna apparatus.

In this case, in a massive MIMO antenna apparatus for mobile communication, in general, the multiple array antenna elements 235 are designed as a plurality of dual polarization antenna module arrays in order to reduce a fading influence attributable to multiple paths and to perform a polarization diversity function.

More specifically, as referred in FIGS. 3 to 4B, the antenna apparatus 100 according to an embodiment of the present disclosure may include an antenna housing part 110 that forms the exteriors of the side and rear of the antenna apparatus 100 on the left and right sides thereof, and a radome panel 300 that forms the exterior of the front of the antenna apparatus 100, that is provided to shield an opened front surface of the antenna housing part 110, and that protects parts (including a main board 120 and an RF module 200 for an antenna described later) provided in an internal space 110S of the antenna housing part 110 against the outside.

Furthermore, as referred in FIGS. 3 to 4B, the antenna apparatus 100 according to an embodiment of the present disclosure includes the main board 120 that is closely installed in the internal space 110S of the antenna housing part 110, a PSU board part 130 disposed on the upper side of the main board 120, and a surge board part 140 disposed on the lower side of the main board 120, and may further include the radio frequency module 200 for an antenna (hereinafter abbreviated as the “RF module”) that is stacked and disposed on a front surface of the main board 120.

Although not illustrated, the antenna housing part 110 may play a role to mediate the coupling of a pillar pole that is provided to install the antenna apparatus 100.

The antenna housing part 110 is generally made of a metal material having excellent thermal conductivity so that heat dissipation according to thermal conduction is advantageous, but may be formed in a rectangular box shape having a front and read direction thickness to the extent that the front end of the RF module 200 described later can be accommodated. However, the antenna housing part 110 is not required to be formed to be longer than the front protrusion length of the RF module 200, and may be formed to have a size that is suitable for accommodating internal parts including the RF module 200 by bending and extending an edge of the radome panel 300 to a rear part thereof.

Meanwhile, the inner side of the antenna housing part 110 may be formed in a shape that is matched with an outward protrusion shape by a digital element (an FPGA element, etc.) mounted on the rear surface of the main board 120 and/or a PSU element mounted on a rear surface of the PSU board part 130, and surge part elements mounted on a rear surface of the surge board part 140. This is for maximizing heat dissipation performance by increasing a thermal contact area with the rear surfaces of the main board 120, the PSU board part 130, and the surge board part 140 to the maximum.

Furthermore, a female socket part 125 to which a male socket part 225 formed in the LNA board part (not illustrated) of an amplification element part 220, among the components of the RF module 200 described later and manufactured in a module unit, is coupled in a socket pin coupling way may be provided on the front surface of the main board 120 and a pin coupling part 127 to which first connecting pin terminals 227 of a left filter part and a right filter part, among the components of the RF module 200, are coupled in a terminal pin coupling way may be provided on the front surface of the main board 120.

Although not illustrated in the drawings, a handle part 190 which may be grasped by a worker on the spot so that the worker can carry the antenna apparatus 100 according to an embodiment of the present disclosure or easily passively perform mounting on the pillar pole (not illustrated) may be further installed on both sides of the antenna housing part 110 on the left and right sides thereof.

Furthermore, various external mounting members 400 for a cable connection with a base station apparatus not illustrated and the tuning of an internal part may be assembled with the antenna housing part 110 outside the bottom thereof through the antenna housing part. The external mounting member 400 is provided in the form of at least one optical cable connection terminal (socket). The connection terminal of a coaxial cable (not illustrated) may be mutually connected to each connection terminal.

Meanwhile, referring to FIGS. 3 to 4B, multiple rear heat dissipation pins 111 may be integrally formed on a rear surface of the antenna housing part 110 so that the multiple rear heat dissipation pins have a predetermined pattern shape. In this case, heat that is generated from the heat-generation elements of the main board 120, the PSU board 130, and the surge board part 140, which have been installed in the internal space 110S of the antenna housing part 110, may be directly dissipated through the multiple rear heat dissipation pins 111.

As referred in FIGS. 3 to 6, the multiple rear heat dissipation pins 111 may be designed to be upward slantly disposed toward left ends and right ends thereof on the basis of central parts thereof in left and right widths thereof so that heat that is dissipated to the back of the antenna housing part 110 forms upcurrents distributed in the left and right directions and is more rapidly distributed. However, the shapes of the multiple rear heat dissipation pins 111 are not essentially limited thereto. For example, although not illustrated in the drawings, if a blower fan module (not illustrated) is further provided so that a flow of an ambient air is smooth on the rear surface side of the antenna housing part 110, the multiple rear heat dissipation pins 111 may be adopted to be formed in parallel to their left ends and right ends in the blower fan module that is disposed at the center so that heat dissipated by the blower fan module is discharged more rapidly.

Meanwhile, the radome panel 300 is coupled to the front end part of the antenna housing part 110, but multiple hook coupling parts 310 provided along the edge of the radome panel 300 may be hook-coupled to a front locking rib 115 of the antenna housing part 110.

Referring to FIGS. 4A and 4B, the RF module 200 may include an RF filter 210 including unit RF filter bodies 211 arranged on the front surface of the main board 120, a radiation element module 230 disposed on a front surface of the unit RF filter body 211, and an amplification element part 220 provided on any one of an upper surface and lower surface of the unit RF filter body 211 in the front and rear thickness part thereof and including an LNA board part (not illustrated) on which at least one analog amplification element (not illustrated) has been mounted.

In general, analog amplification elements have severe operating heat. Accordingly, for more efficient heat dissipation, the analog amplification elements are mounted on the front surface or rear surface of the main board 120 along with heat-generation elements such as digital elements (an FPGA, etc.). However, only LNA elements having slightly small heat generation, among the analog amplification elements, are separated from the main board 120 and distributed and mounted on an LNA board part, among the components of the amplification element part 220 of the RF module 200. Accordingly, there is an advantage in that a concentration of heat dissipation when heat is dissipated to the rear of the antenna housing part 110 can be solved because other analog amplification elements (e.g., Tx and Rx element) and digital elements are spaced apart further from the main board 120.

In this case, a reflector panel 219 that is formed to extend wider than the area of the front surface of the unit RF filter body 211 and that grounds (GND) the radiation element module 230 may be further provided on the front surface of the unit RF filter body 211.

The reflector panel 219 may perform a function for improving the directivity and gain of a signal by reflecting the signal that is radiated by an array antenna element 235, among the components of the radiation element module 230.

Furthermore, the reflector panel 219 may perform a ground (GND) function in addition to the function of reflecting a signal.

More specifically, the reflector panel 219 is integrally formed on the front surface of the unit RF filter body 211 of each RF module 200, and does not come into direct contact with the reflector panel 219 of an adjacent RF module 200, but is disposed very closely to the reflector and perform the ground function while dividing a front part of the unit RF filter body 211 and a volume part in which the unit RF filter body 211 is accommodated and occupied.

Furthermore, although not illustrated the in drawings, multiple cavities that are opened to the outside on the left and right sides thereof are formed on the left and right sides of the unit RF filter body 211. A resonator is embedded in each cavity, and a left filter part and a right filter part that perform different frequency filtering may be provided. The left filter part and the right filter part may be designed as filters for a frequency band of 2.4G and a frequency band of 5G, respectively, and may implement a dual band antenna by one RF module 200.

Meanwhile, the radiation element module 230 may be provided to generate at least one polarization of a dual polarization.

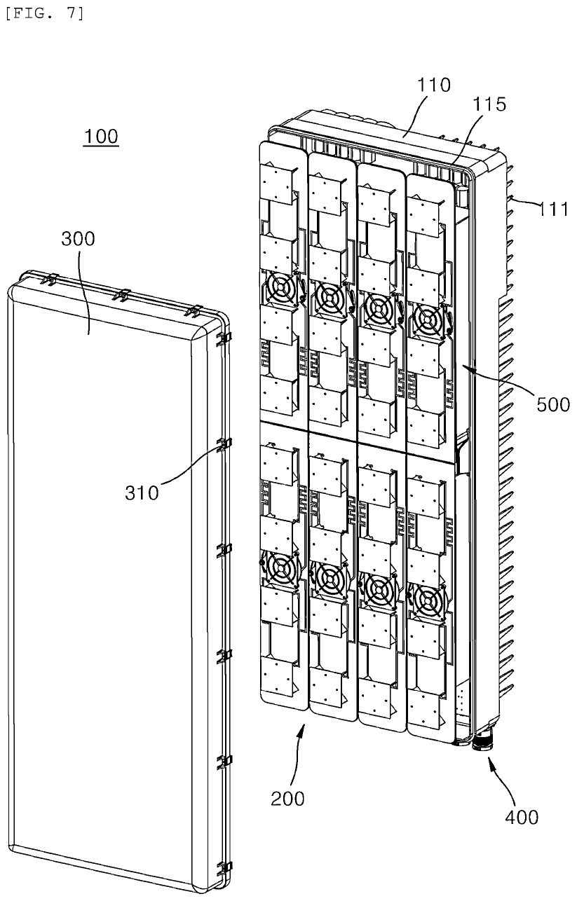

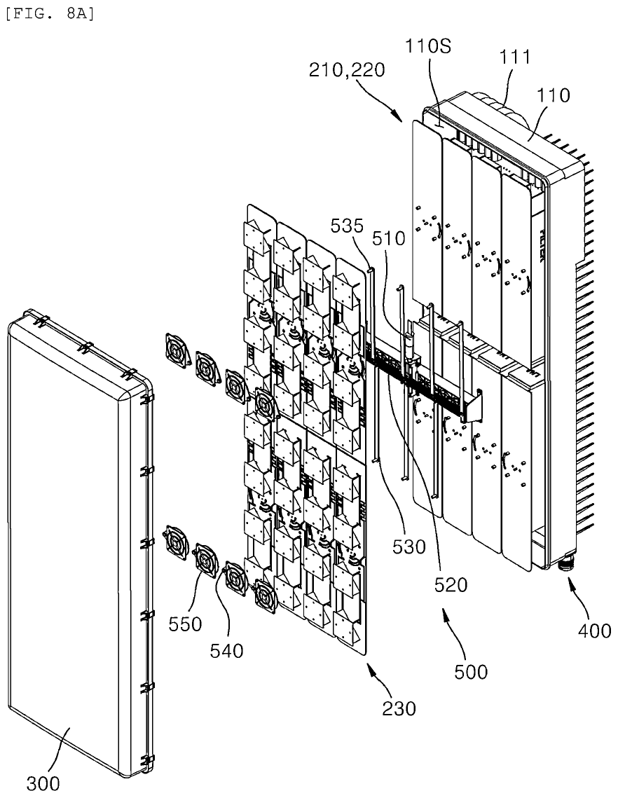

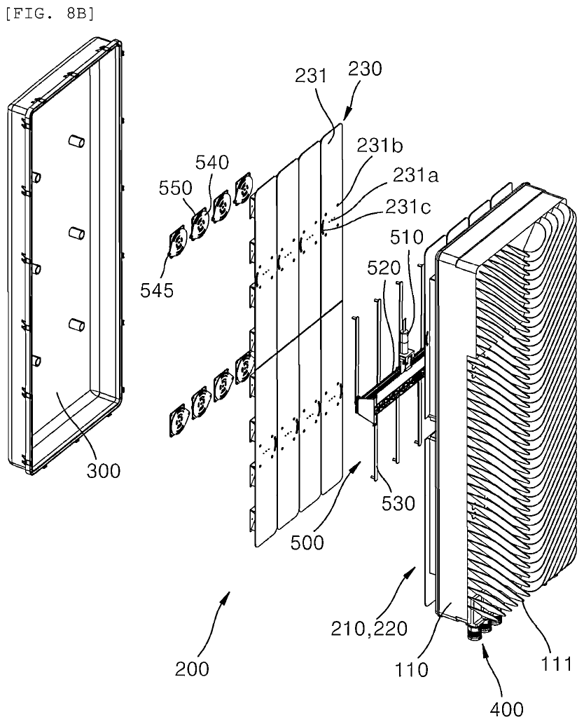

More specifically, as referred in FIGS. 7 to 8B, the radiation element module 230 may include an antenna element board 231 disposed on a front surface of the reflector panel 219, power feeding bases 233 that are attached to a front surface of the antenna element board 231, that are electrically connected to the left filter part and the right filter part, and that are intersected and arranged in an “X” shape, and array antenna elements 235 each provided at the front end part of the power feeding base 233.

The array antenna element 235 is formed in an approximately square shape. The power feeding base 233 is disposed to diagonally support each corner part of the array antenna element 235, and each feeding end thereof is extended to be disposed at a central part of each side of the array antenna element 235 and feed-connected thereto. Accordingly, each power feeding base 233 may implement a dual polarization by generating each polarization.

In this case, the array antenna elements 235 may be disposed so that four array antenna elements per one unit RF filter body 211 are spaced apart from each other in the up and down directions (V-direction). The four array antenna elements 235 may each output two different phase shift values by a phase shifter 500 described later. This is described below more specifically.

The antenna element board 231 may be electrically connected to mediate the transfer of transmission signals from the left filter part and the right filter part that are formed on the left and right sides of the unit RF filter body 211 and a reception signal from the array antenna element 235.

Meanwhile, in the antenna apparatus 100 according to an embodiment of the present disclosure, the radiation element module 230 is described as being limited to any one of a patch type and a dipole type, but is not essentially limited thereto.

Furthermore, even in a method of implementing the aforementioned antenna element board 231, the method may be applied to a PCB type in which transmission lines not illustrated have been pattern-printed, but it is to be noted that the application of an air strip type feeding method is not excluded. However, in an embodiment of the present disclosure, an embodiment in which the method is applied to the PCB type is described in order to describe the method in association with an operation with the phase shifter 500 described later.

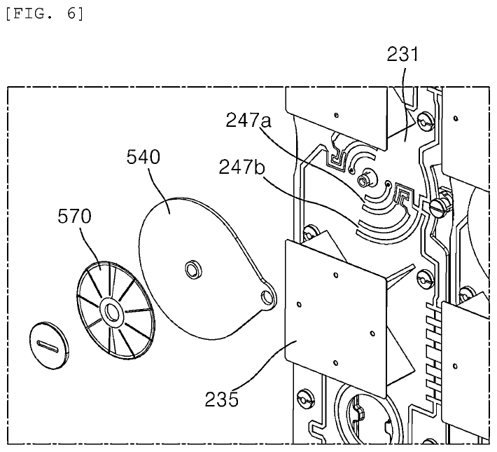

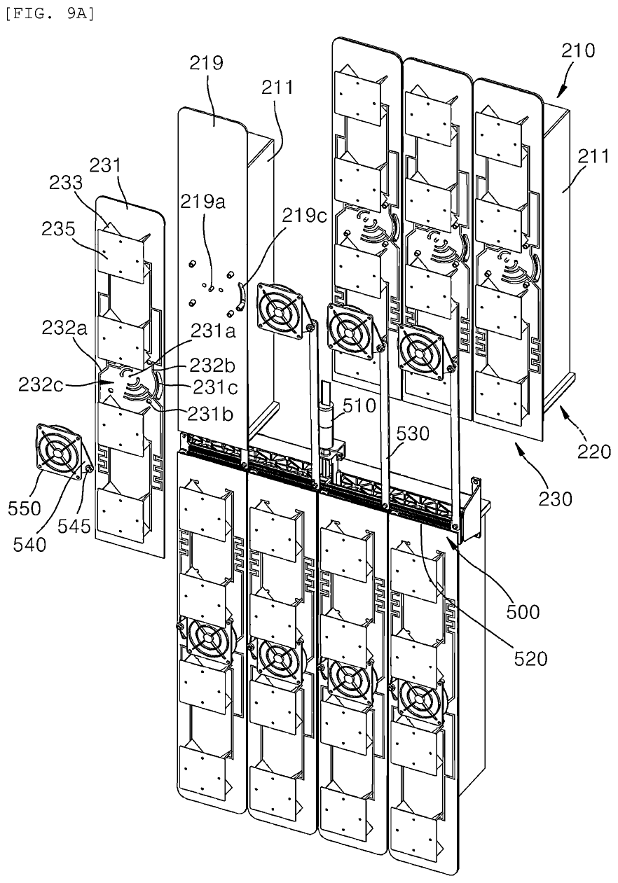

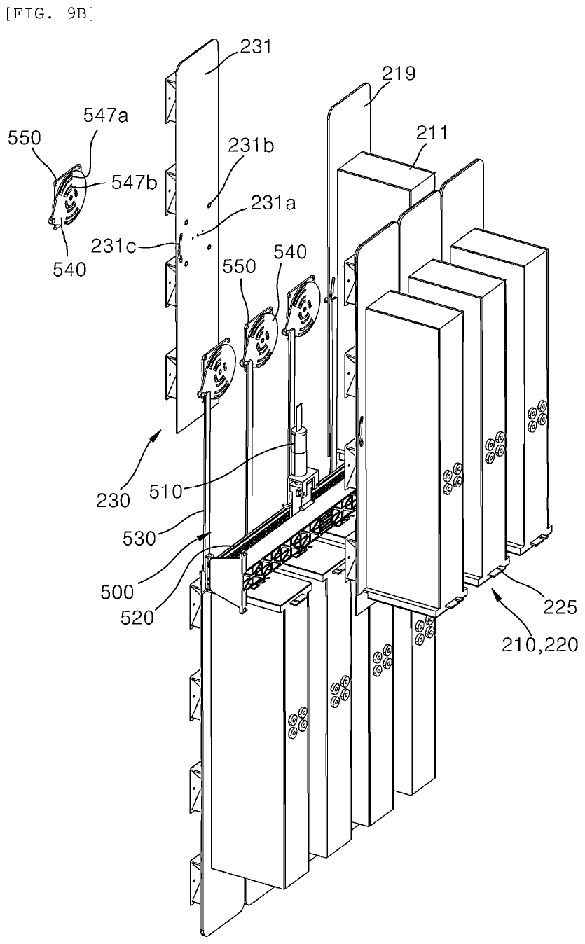

FIG. 5 is a front view and rear view illustrating an operation form of the phase shifter, among components of an embodiment of the present disclosure. FIG. 6 is an enlarged and exploded perspective view of a part “D” in FIG. 5. FIG. 7 an exploded is perspective view illustrating the state in which the radome panel, among the components of FIG. 3, has been separated. FIGS. 8A and 8B are exploded perspective views of the front part and the rear part in which the phase shifter, among the components of FIG. 3, has been exposed to the outside. FIGS. 9A and 9B are diagrams illustrating the phase shifter, among the components of FIG. 3, and are exploded perspective views of the front part and the rear part in the state in which the housing part have been radome panel and the antenna removed.

As referred in FIGS. 5 to 9 (in particular, refer to FIG. 6), the antenna apparatus 100 according to an embodiment of the present disclosure may further include the full analog phase shifter (hereinafter abbreviated as the “phase shifter”) 500 including multiple variable switch panels 540 that change the length of a transmission line by a rotation operation in a separation space (a reference numeral not indicated) that is defined between the front surface of the antenna element board 231 of the radiation element module 230 and the rear surface of the four array antenna elements 235.

As referred in FIGS. 5 to 9, the phase shifter 500 may further include a phase shift driving motor 510 disposed in a space corresponding to the front and rear thickness part of the unit RF filter body 211 as the rear side of the antenna element board 231, a horizontal mounting bar 520 that is moved in the up and down directions by the driving force of the phase shift driving motor 510, and multiple vertical mounting bars 530 each having one end connected to the horizontal mounting bar 520 and the other end vertically extended upward or downward and connected to each of the multiple variable switch panels 540. A detailed driving form of the phase shifter 500 is more specifically described later.

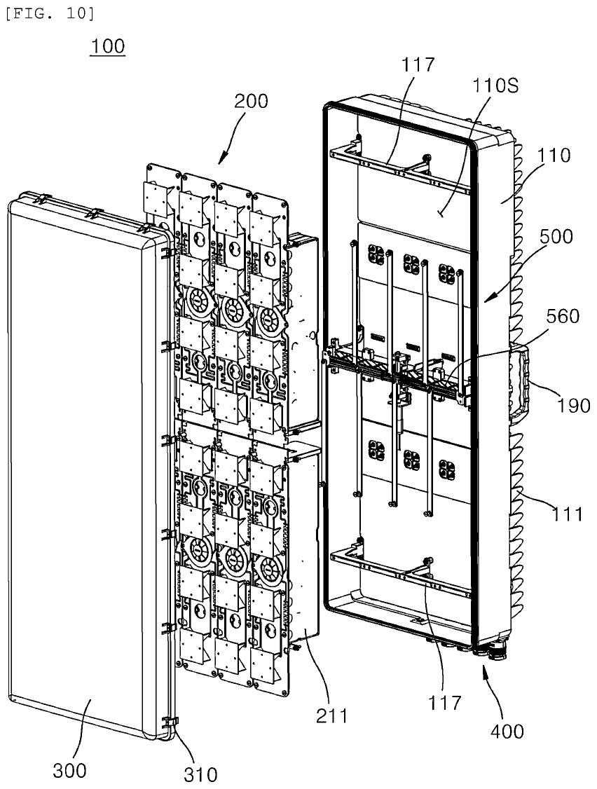

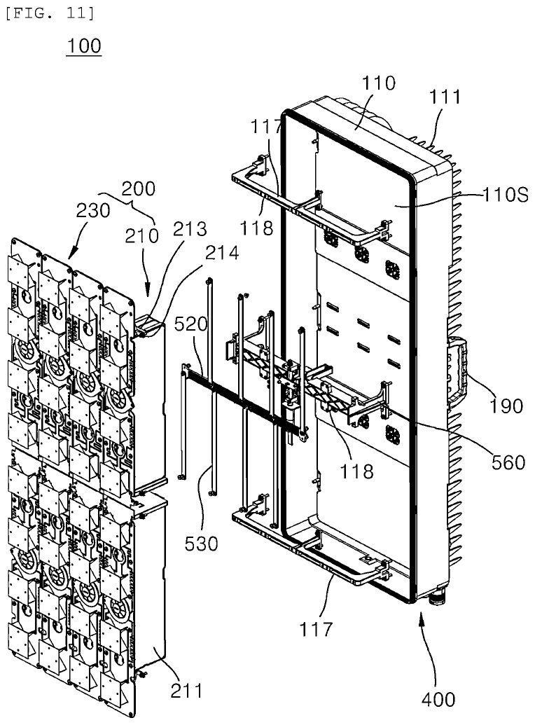

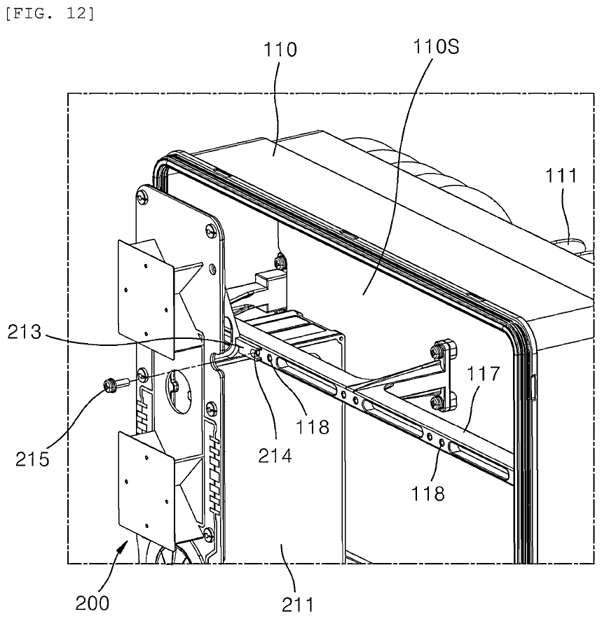

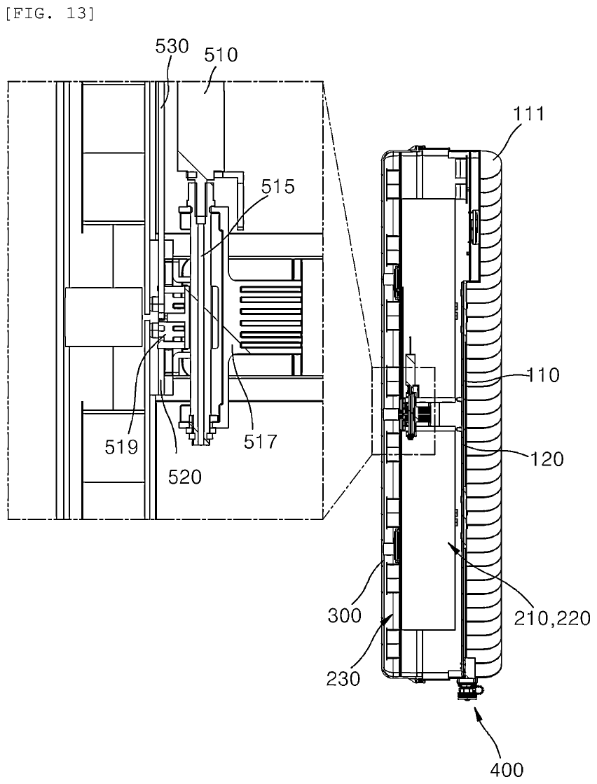

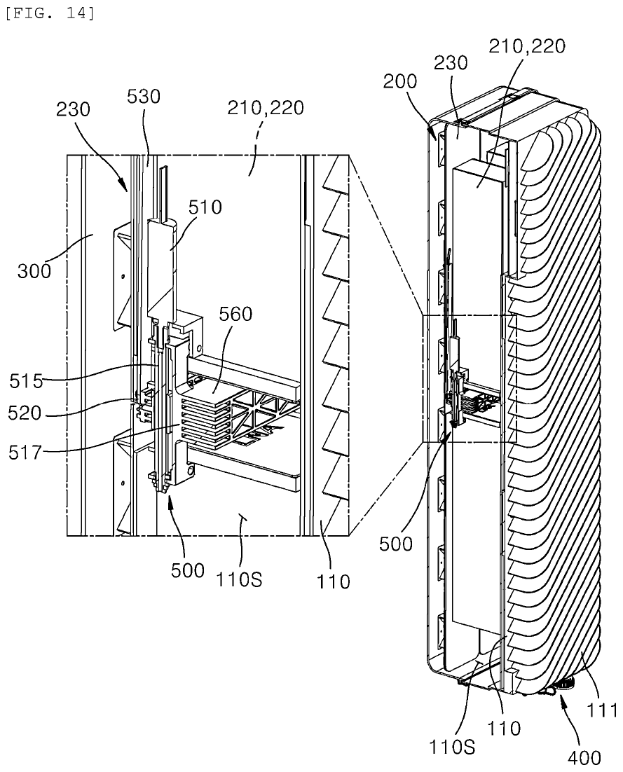

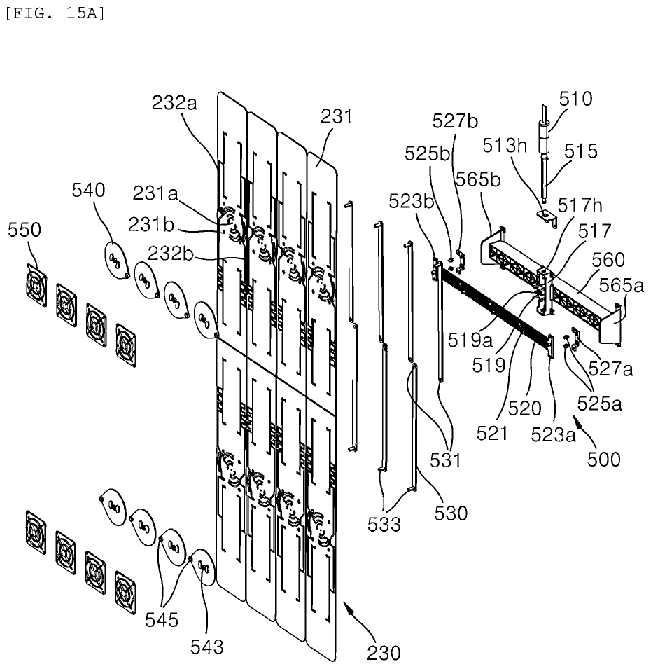

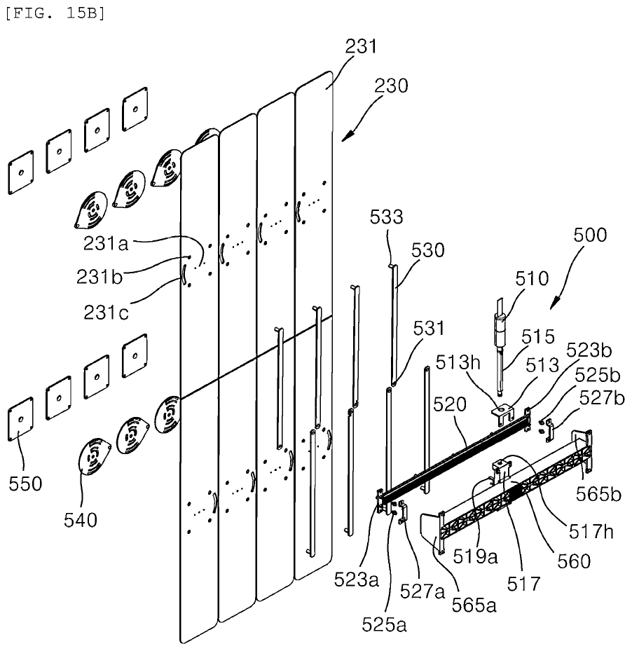

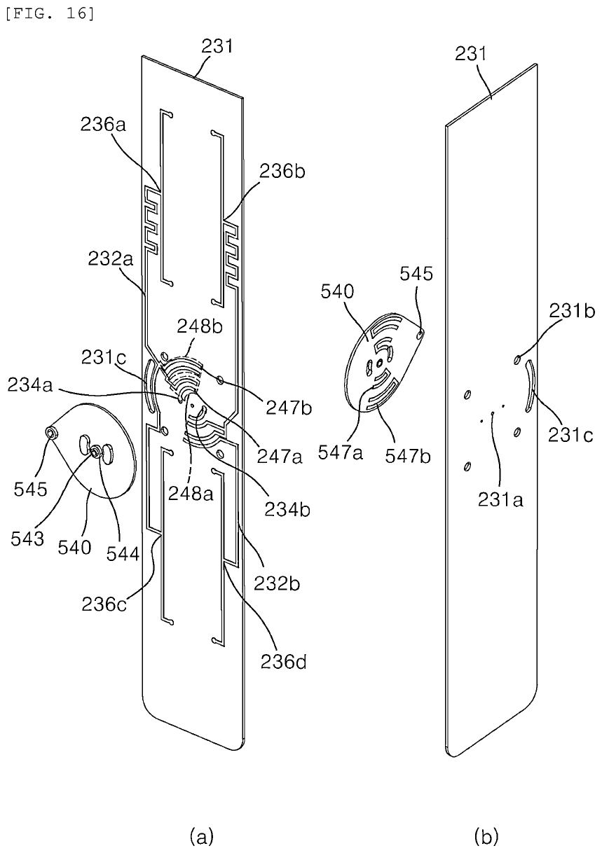

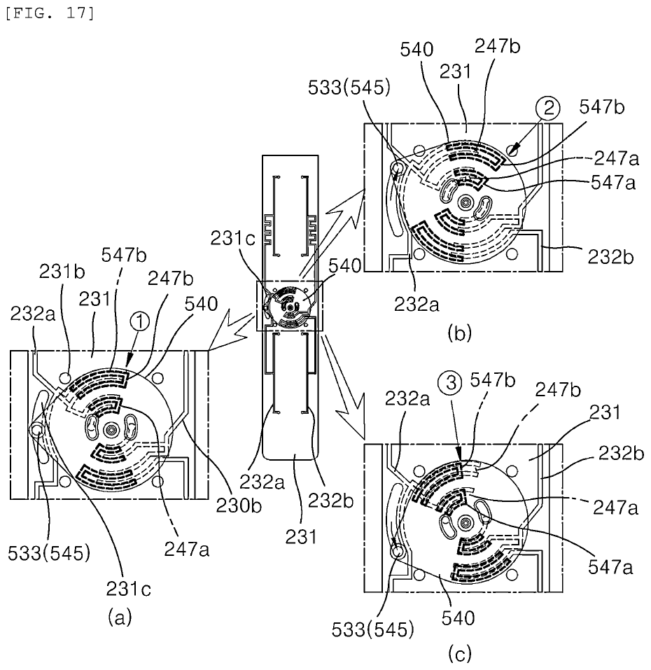

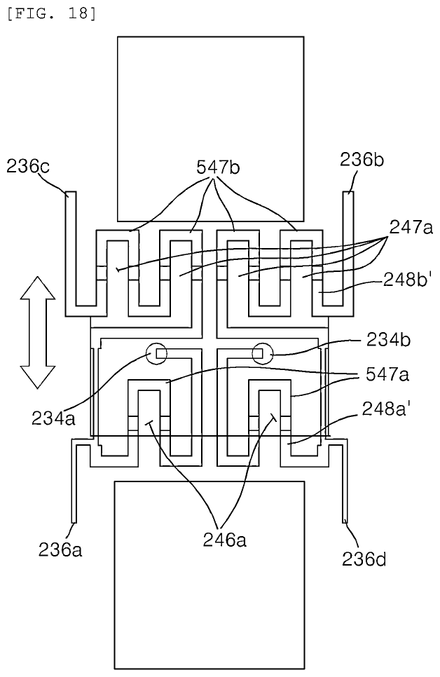

FIG. 10 is an exploded perspective view illustrating an installation form of the phase shifter for the antenna housing part. FIG. 11 is an exploded perspective view of a part of the phase shifter fixed to a middle portion of the antenna housing part, among the components of FIG. 10. FIG. 12 is an exploded perspective view illustrating a fixed form of the unit RF module for a fixing bridge bar that is fixed to a top portion of the antenna housing part, among the components of FIG. 10. FIGS. 13 and 14 are a cross-sectional view and incisional perspective view illustrating the phase shifter, among the components of FIG. 3, and a partial enlargement view thereof. FIGS. 15A and 15B are exploded perspective views of the front part and the rear part illustrating the arrangement relation of the phase shifter centering around the antenna element board, among the components of FIG. 3. FIG. 16 is an exploded perspective view of the front part and the rear part for describing a switching operation form of the variable switch panel for the antenna element board, among the components of FIG. 3. FIG. 17 is a front view of the antenna element board illustrating a contact point change of a transmission line pattern form in a first embodiment for the implementation of a phase difference of a mirror symmetry structure and a partial enlargement view thereof. FIG. 18 is a front view of the antenna element board illustrating a transmission line pattern form in a second embodiment for the implementation of a phase difference of the mirror symmetry structure.

As referred in FIG. 16, two input stages (hereinafter referred to as a “first input stage 234a” and a “second input stage 234b”) formed to penetrate the front and rear of the antenna element board 231, and two output stages (hereinafter, output stages that are branched off from the first input stage 234a are denoted as a “first output stage 236a” and a “third output stage 236c”, and output stages that are branched off from the second input stage 234b are denoted as a “second output stage 236b” and a “fourth output stage 236d”) that are branched off from each of the two input stages (the first input stage 234a and the second input stage 234b), respectively, may be formed on the front surface of the antenna element board 231.

Each of the two input stages 234a and 234b and the four output stages 236a to 236d may receive signals that are generated by a processor of a transmission apparatus (e.g., a base station) (not illustrated) and a radio frequency (RF) circuit. In particular, the two input stages 234a and 234b may transmit an input signal to the phase shifter 500 in order to change a physical transmission line described later.

Referring to FIG. 16, the first output stage 236a and the third output stage 236c that are branched off from the first input stage 234a may be spaced apart from each other in the vertical direction (V-direction) and disposed at the end of the front surface of the antenna element board 231 on the left side thereof. The second output stage 236b and the fourth output stage 236d that are branched off from the second input stage 234b may be spaced apart from each other in the vertical direction and disposed at the end of the front surface of the antenna element board 231 on the right side thereof.

Each of the output stages 236a to 236d may be branched off to have the same transmission length in the up and down directions, and may include a pair of element feeding lines (reference numerals not indicated) in each of which an element feeding point (reference numeral not indicated) is formed at a front end thereof. The pair of array antenna elements 235 may be provided in the pair of element feeding points that are provided at the same height of the pair of element feeding lines up and down, respectively, so that the same dual polarization beam is output, and may be fed with power therefrom.

In this case, two antenna element boards 231 are arranged in the vertical direction. A power feeding signal is input from each TRx module to each of the input stages (the first input stage 234a of the antenna element board 231 on an upper side and the second input stage 234b of the antenna element board 231 on a lower side). The power feeding signal that is transmitted through each of the input stages 234a and 234b is output to each of the output stages (the first output stage to the fourth output stage 236a to 236d) through each transmission line that is conducted through a contact point for an inside variable circuit 547a and outside variable circuit 547b of the variable switch panel 540, which are described later.

More specifically, a one side-transmission line 232a and the other side-transmission line 232b for transmitting signals between the one side-transmission line and the other side-transmission line and the four array antenna elements 235 are pattern-printed on the front surface of the antenna element board 231, but may be pattern-printed to have a first power-off point 247a and a second power-off point 247b, respectively, for a change in the lengths of the physical transmission lines by the two variable circuits (the inside variable circuit 547a and the outside variable circuit 547b) between at least the input stage and the output stage.

In this case, the one side-transmission line 232a may be defined as a transmission line having a form in which the first output stage 236a is connected from the first input stage 234a and a transmission line having a form in which the third output stage 236c is connected from the first input stage 234a. The other side-transmission line 232b may be defined as a transmission line having a form in which the second output stage 236b is connected from the second input stage 234b and a transmission line having a form in which the fourth output stage 236d is connected from the second input stage 234b.

As described above, the first output stage 236a, among the first output stage 236a and the third output stage 236c branched off from the first input stage 234a, may be disposed on the upper side of an end of the antenna element board 231 on the left side thereof in the vertical direction. The third output stage 236c, among the first output stage 236a and the third output stage 236c, may be disposed on the lower side of the end of the antenna element board 231 on the left side thereof in the vertical direction.

Furthermore, the second output stage 236b, among the second output stage 236b and the fourth output stage 236d branched off from the second input stage 234b, may be disposed on the upper side of an end of the antenna element board 231 on the right side thereof in the vertical direction. The fourth output stage 236d, among the second output stage 236b and the fourth output stage 236d, may be disposed on the lower side of the end of the antenna element board 231 on the right side thereof in the vertical direction.

Therefore, the first output stage 236a and the second output stage 236b that are formed in one antenna element board 231 may be placed at the same height above the first input stage 234a and the second input stage 234b, and the third output stage 236c and the fourth output stage 236d formed therein may be placed at the same height below the first input stage 234a and the second input stage 234b.

In this case, the first power-off point 247a may be defined as a part that is disconnected at a location close to the first input stage 234a and the second input stage 234b before being branched off to the first output stage 236a and the third output stage 236c and before being branched off to the second output stage 236b and the fourth output stage 236d, from the first input stage 234a or the second input stage 234b, in the one side-transmission line 232a or the other side-transmission line 232b. The second power-off point 247b may be defined as a point at which a part of the transmission line extended to the third output stage 236c and the fourth output stage 236d after being branched off from the first input stage 234a or the second input stage 234b to the first output stage 236a and the third output stage 236c is disconnected.

This is described more particularly with reference to FIG. 16. An internal variable circuit 248a that is pattern-printed in an arc shape having a first radius from the first input stage 234a and the second input stage 234b and an external variable circuit 248b that is pattern-printed in an arc shape having a second radius to the outside of the internal variable circuit 248a are formed on the front surface of the antenna element board 231. The internal variable circuit 248a and the external variable circuit 248b are provided in an inside arc and an outside arc, respectively, and may form the first power-off point 247a and the second power-off point 247b that are primarily spaced apart from each other.

The end of the start of the external variable circuit 248b that is formed on the side of the first input stage 234a may be branched off and extended to the first output stage 236a and the third output stage 236c. The end of the start of the external variable circuit 248b that is formed on the side of the second input stage 234b may be branched off and extended to the second output stage 236b and the fourth output stage 236d.

In this case, the external variable circuit 248b may be defined as a part at which a part of the transmission line extended to the third output stage 236c after being branched off to the first output stage 236a and the third output stage 236c is disconnected and a part at which a part of the transmission line extended to the fourth output stage 236d after being branched off to the second output stage 236b and fourth the output stage 236d is disconnected.

Therefore, the power feeding signal that is input from the TRx module may be conducted through only the first power-off point 247a corresponding to the internal variable circuit 248a, in the transmission lines that connects the first input stage 234a and the first output stage 236a and the second input stage 234b and the second output stage 236b, as a contact point through the first conduction pattern terminal 547a of the variable switch panel 540. An input stage power feeding signal from the TRx module may be conducted through the second power-off point 247b corresponding to the external variable circuit 248b in addition to the first power-off point 247a corresponding to the internal variable circuit 248a, in the transmission lines that connect the first input stage 234a and the third output stage 236c and the second input stage 234b and the fourth output stage 236d, as a simultaneous contact point through the first conduction pattern terminal 547a and second conduction pattern terminal 547b of the variable switch panel 540.

For reference, as referred in FIG. 16, the transmission line that is branched off from the first input stage 234a and that is extended to the first output stage 236a and the transmission line that is branched off from the first input stage and that is extended to the third output stage 236c are pattern-printed so that they intersect the front surface of the antenna element board 231, but may be pattern-printed so that they are not electrically connected. Accordingly, the transmission lines that are branched off from the first input stage 234a to the first output stage 236a and the third output stage 236c, respectively, do not have electrical influences on each other.

Meanwhile, the first conduction pattern terminal 547a and the second conduction pattern terminal 547b that conduct the first power-off point 247a and the second power-off point 247b (i.e., the variable circuits at two places) and that implement a phase difference may be pattern-printed on the rear part of the variable switch panel 540. In this case, the variable switch panel 540 may be made of a plastic resin material. The first conduction pattern terminal 547a and the second conduction pattern terminal 547b may be made of conductors and manufactured by an insert injection process. As in an embodiment of the present disclosure, the variable switch panel 540 may be formed in the form of a PCB of an FR4 material. The first conduction pattern terminal 547a and the second conduction pattern terminal 547b may be formed by a circuit printing process for a common PCB.

The first conduction pattern terminal 547a and the second conduction pattern terminal 547b that are formed in the variable switch panel 540 are also formed to have the same radii as the internal variable circuit 248a and the external variable circuit 248b formed in the antenna element board 231, respectively, but may each be formed in an arc shape of an approximately “C” shape and may be connected.

The first conduction pattern terminal 547a performs a role of connecting the first power-off points 247a. The second conduction pattern terminal 547b performs a role of connecting the second power-off points 247b.

Such a variable switch panel 540 may be provided in a rotator type in which the variable switch panel connects the first power-off point 247a and the second power-off point 247b and also changes the length of the transmission line that has been pattern-printed on the antenna element board 231 while being rotated in a predetermined angle range.

In this case, the phase shifter 500 may be changed so that a ratio (e.g., the first input stage 234a-first output stage 236a: the first input stage 234a-third output stage 236c, the second input stage 234b-second output stage 236b: or the second input stage 234b-fourth output stage 236d) of a length up to each output stage that is branched off on the basis of one input stage is a predetermined ratio when the first power-off point 247a and the second power-off point 247b are conducted by the first conduction pattern terminal 547a and the second conduction pattern terminal 547b. In this case, the predetermined ratio needs to be set so that beam phase values of radiation elements that constitute the antenna array element 235 have linearity. For example, it is preferred that the predetermined ratio is 1:3. That is, the variable switch panel 540 may implement a phase difference by changing the entire length of the one side-transmission line 232a and the other side-transmission line 232b while rotating around a rotation central point thereof at a predetermined angle.

Meanwhile, in the full analog phase shifter 500 according to an embodiment of the present disclosure, a shape of a pattern formed in the antenna element board 231 is not limited to the aforementioned arc shape.

That is, referring to FIG. 18, in the full analog phase shifter 500, the variable switch panel 540 may be provided in a slider type in which the variable switch panel slides and moves in the up and down directions in the front surface of the antenna element board 231, and may implement a phase difference according to the sliding and moving distance.

In this case, the shape of the pattern that is printed and formed on the front surface of the antenna element board 231 may be a concavo-convex shape including a lower variable circuit 248a′ and an upper variable circuit 248b′. In this case, it is preferred that the lower variable circuit 248a′ is formed before being branched off from the first input stage 234a to the first output stage 236a and the third output stage 236c and before being branched off from the second input stage 234b to the second output stage 236b and the fourth output stage 236d. It is preferred that the upper variable circuit 248b′ is formed at a transmission line portion that connects the third output stage 236c and the fourth output stage 236d after being branched off from each of the input stages 234a and 234b.

As described above, as referred in FIG. 16, if the two variable switch panels 540 are provided in the slider type in which the two variable switch panels slide in the vertical direction, it is preferred that the two variable switch panels slide in the same direction, on the premise that all of the transmission lines including the first power-off point 247a and the second power-off point 247b pattern-printed on the two antenna element boards 231 are symmetrical to each other.

Meanwhile, referring to FIGS. 13 and 14, the phase shift driving motor 510 may be disposed to construct a rotation axis in the up and down directions in a space between the adjacent unit RF filter bodies 211 as a space corresponding to the front and rear thickness part of the unit RF filter body 211.

A screw rod 515 having a male screw thread formed on an outer circumferential surface thereof and extended in a predetermined length in the direction of the rotation axis may be provided in the rotation axis of the phase shift driving motor 510.

In this case, a rod through part 519a through which the screw rod 515 penetrates in the up and down directions is formed in the phase shifter 500. An arm screw thread (not illustrated) that is fastened to the male screw thread of the screw rod 515 is formed in the rod through part 519a. The phase shifter may further include an up and down moving block 519 that is moved in the up and down directions in response to the rotation direction of the screw rod 515 and a block guide part 517 that provides guidance to an up and down movement of the up and down moving block 519.

Meanwhile, the phase shifter 500 may further include a horizontal bracket part 560 that is left and right horizontally disposed within the antenna housing part 110 in which the main board 120, etc. have been installed so that the block guide part 517 is fixed.

As referred in FIG. 10, the horizontal bracket part 560 is lengthily fixed at a middle part of the internal space 110S of the antenna housing part 110 in the left and right horizontal direction, and performs a support role so that the phase shifter 500 can perform a stable driving operation.

More specifically, three fixing bridge bars 117 for firmly fixing the multiple unit RF filter bodies 211 to the internal space 110S of the antenna housing part 110 may be provided in the internal space 110S of the antenna housing part 110.

The three fixing bridge bars 117 may be fixed to a top portion, bottom portion, and middle portion of the internal space 110S of the antenna housing part 110, respectively, in a bridge form so that the three fixing bridge bars are spaced apart from the inner side of the internal space 110S to the front side thereof at a predetermined distance.

The horizontal bracket part 560 may be fixed and installed in a front surface of the at least one fixing bridge bar 117 that is constructed in the middle portion of the three fixing bridge bars 117 or may be installed as a concept in which the horizontal bracket part replaces the fixing bridge bar 117 constructed in the middle portion. In an embodiment of the present disclosure, as referred in FIGS. 10 to 12, the horizontal bracket part 560 has been implemented to substitute the fixing bridge bar 117 that is provided in the middle portion of the internal space 110S of the antenna housing part 110. Therefore, it is preferred that the fixing bridge bar 117 and the horizontal bracket part 560 that are provided in the middle portion are interpreted as denoting the same component.

That is, as referred in FIGS. 10 to 12, the at least one fixing bridge bar 117 may be left and right horizontally extended and formed in the top portion, bottom portion, and middle portion of the internal space 110S of the antenna housing part 110. The horizontal bracket part 560 may be fixed to the internal space 110S of the antenna housing part 110 so that the horizontal bracket part substitutes any one of the at least one fixing bridge bar 117, but may be fixed to substitute the fixing bridge bar 117 formed in the middle portion.

However, the horizontal bracket part 560 does not need to essentially substitute the fixing bridge bar 117 provided in the middle portion of the internal space 110S of the antenna housing part 110, and may be fixed through the medium of the fixing bridge bar 117 provided in the middle portion as described above.

In this case, the fixing bridge bar 117 that is provided in the middle portion of the internal space 110S of the antenna housing part 110 and that mediates the fixing of the horizontal bracket part 560 or the horizontal bracket part 560 that substitutes the fixing bridge bar 117 may be provided in a space between the two unit RF filter bodies 211 in the up and down directions, assuming that the two unit RF filter bodies 211 are arranged in the up and down vertical directions (V-direction). This is for allowing the horizontal mounting bar 520 to be moved in the up and down directions without interfering with the unit RF filter body 211 while maintaining left and right horizontality in the space.

Meanwhile, as referred in FIGS. 11 and 12, multiple screw fastening holes 118 for a screw assembly with the unit RF filter body 211 by a fixing screw 215 may be formed in the fixing bridge bar 117 or the horizontal bracket part 560 that substitutes the fixing bridge bar 117.

In this case, as referred in FIG. 12, a screw mounting part 213 in which a screw fastening groove 214 through which the fixing screw 215 penetrates has been formed may be provided at the top and/or bottom of the unit RF filter body 211. The screw mounting part can firmly fix the fixing screw 215 to the unit RF filter body 211 through the screw fastening groove 214 of the screw mounting part 213 and the screw fastening hole 118 of the horizontal bracket part 560 or the fixing bridge bar 117.

Meanwhile, as referred in FIGS. 15A and 15B, a phase shift driving motor 510 may be installed in the horizontal bracket part 560 through the medium of a motor installation bracket 513 through which an axis through hole 513h has been formed to penetrate in the up and down directions. That is, the phase shift driving motor 510 is firmly fixed to the horizontal bracket part 560 that is provided in the internal space 110S of the antenna housing part 110 in the fixing type through the medium of the motor installation bracket 513, so that the screw rod 515 can rotate in place in the internal space 110S of the antenna housing part 110.

Meanwhile, although not illustrated in the drawing, the phase shift driving motor 510 may be fixed and installed in a separate structure (e.g., including a structure having a form of a support hole in which the phase shift driving motor 510 may be inserted and installed) that is provided outside the multiple unit RF filter bodies 211 that are adjacent to the phase shift driving motor.

The screw rod 515 that is connected to the rotation axis of the phase shift driving motor 510 may be inserted into an axis through hole 513h of the motor installation bracket 513 and a guide hole 517h formed in the block guide part 517 in a way to penetrate the block guide part in the up and down directions, and may be then fixed to the arm screw thread of the rod through part 519a of the up and down moving block 519.

The horizontal mounting bar 520 may be hook-coupled to the front of the up and down moving block 519 by a hook part 519b that is formed in the front end part of the up and down moving block 519, so that both ends of the horizontal mounting bar 520 can be moved generally up and down without leaning to one side when the up and down moving block 519 is moved within the block guide part 517 in the up and down directions.

Meanwhile, a left support panel 565a and a right support panel 565b that are fixed to a left inside wall and right inside wall of the antenna housing part 110 may be provided at both ends of the horizontal bracket part 560, respectively.

Furthermore, bearing wheels 525a and 525b that are rotatably supported by the left support panel 565a and right support panel 565b of the horizontal bracket part 560 may be provided at both ends of the horizontal mounting bar 520, respectively.

The left bearing wheel 525a and the right bearing wheel 525b are rotatably installed in a left bearing housing 527a and a right bearing housing 527b that are coupled to rear surfaces of both ends of the horizontal mounting bar 520, and are rotatably supported by the left support panel 565a and right support panel 565b of the bracket part 560, thus playing a role of horizontal smoothing the up and down moving of the horizontal mounting bar 520.

Meanwhile, the vertical mounting bar 530 is provided to correspond to the number of unit RF filter bodies 211. For example, referring to FIG. 11, if eight unit RF filter bodies 211 four of which are arranged on an upper side of the front surface of the main board 120 left and right and the remaining four of which are arranged on a lower side thereof left and right are arranged and have a total of 16T16R (16 for transmitting and 16 for receiving) transmission and reception paths, the vertical mounting bar 530 may be provided to have a number corresponding to the number of eight unit RF filter bodies 211.

Multiple hinge coupling protrusions 521 to be hinged and coupled to any one (defined as “one end” in an embodiment of the present disclosure) of one end and the other end of the vertical mounting bar 530 may be formed on the front surface of the horizontal mounting bar 520 in a way to protrude forward. Hinge coupling holes 531 that are hinged and coupled to the hinge coupling protrusions 521 of the horizontal mounting bar 520, respectively, may be formed in one end of the vertical mounting bar 530.

Meanwhile, the variable switch panel 540 is formed in an approximately circular panel form, and may be formed in a shape in which a part of the circumference of the variable switch panel protrudes to one side thereof. Hinge insertion holes 545 to which hinge pins 533 that are bent forward and integrally formed at the other end (defined as the “other end” in an embodiment of the present disclosure), among one end and the other end of the vertical mounting bar 530, are hinged and coupled therethrough may be formed at the protruded portion of the variable switch panel 540 having the rotator type in which a part of the circumference of the variable switch panel protrudes.

The hinge pin 533 of the vertical mounting bar 530 may be hinged and coupled to the hinge insertion hole 545 of the variable switch panel 540 through the reflector panel 219 formed in the antenna element board 231 and the front surface of the unit RF filter body 211.

Meanwhile, an arc type guide slit 231c that provides guidance to an arc movement of the hinge pin 533 of the vertical mounting bar 530 may be formed in the reflector panel 219 and the antenna element board 231.

In this case, a rotation hole 231a to which a central part of the variable switch panel 540 is connected so that the variable switch panel 540 is rotatably fixed to a rotation central point of the variable switch panel on the front surfaces of the two variable circuits (the internal variable circuit 248a and the external variable circuit 248b) may be formed in the antenna element board 231.

A fixing hole 543 or a screw boss 544 including the fixing hole 543 may be provided at the central part of the variable switch panel 540. A fixing screw not illustrated may penetrate the rotation hole 231a formed in the antenna element board 231, and may rotatably fix the variable switch panel 540 by an operation of being fastened to a screw fastening hole (not illustrated) that is formed in the front surface of the reflector panel 219 of the unit RF filter body 211.

However, the fixing structure of the variable switch panel 540 is not essentially limited by the aforementioned embodiment. Although not illustrated, the central part of the variable switch panel 540 may be provided in a hinge form, and may be connected to a hinge connection part 219a provided so that the central part of the variable switch panel 540 can be connected to the front surface of the reflector panel 219 of the unit RF filter body 211 through the rotation hole 231a formed in the antenna element board 231.

Meanwhile, four cover coupling holes 231b to which the rotator cover 550 that covers the variable switch panel 540 in front thereof is coupled may be formed in the antenna element board 231. Four coupling ribs (reference numerals not indicated) formed to protrude from the rear surface of each corner part of the rotator cover 550 to the rear side thereof may be inserted and coupled to the four cover coupling holes 231b, respectively, and may perform a role of allowing a protruded portion of the variable switch panel 540 to rotatably move within the range of the guide slit 231c while covering the variable switch panel 540 because the protruded portion of the variable switch panel 540 protrudes between the two coupling ribs.

Furthermore, as referred in FIG. 6, the phase shifter 500 may further include an elastic member 570 that elastically supports the variable switch panel 540 to the antenna element board 231 between the variable switch panel 540 and the rotator cover 550.

The elastic member 570 may perform a role of continuously maintaining a contact point by applying an elastic force so that the first conduction pattern terminal 547a and the second conduction pattern terminal 547b that are formed in the rear part of the variable switch panel 540 are sufficiently closely attached to the first power-off point 247a and second power-off point 247b of the antenna element board 231.

Any component that assigns a uniform elastic force to the variable switch panel 540 may be adopted as such an elastic member 570. In an embodiment of the present disclosure, the elastic member 570 is limited as being provided as a leaf spring.

The antenna apparatus 100 constructed as described above according to an embodiment of the present disclosure provides an advantage in which space utilization is improved because in particular, the phase shifter 500 is provided so that the variable switch panel 540 is rotated in the separation space between the front surface of the antenna element board 231 and the rear surface of the array antenna element 235, and the phase shift driving motor 510, the horizontal mounting bar 520, and the vertical mounting bar 530, which occupy a relatively great space, and various components (the horizontal bracket part 560, etc.) coupling them are efficiently installed in the existing space between the multiple unit RF filter bodies 211.

Meanwhile, the variable circuits (the lower variable circuit 248a′ and the upper variable circuit 248b′) that are pattern-printed on the antenna element board 231 may each be formed in a concavo-convex shape, as referred in FIG. 18.

That is, the transmission line may be pattern-printed on the antenna element board 231 so that the transmission line is extended in a straight-line shape from the first input stage 234a and the second input stage 234b to the lower side thereof, but has the first power-off point 247a at some points before being branched off to the first output stage 236a and the third output stage 236c and before being branched off to the second output stage 236b and the fourth output stage 236d, and the transmission line is extended to the upper side of the first input stage 234a and the second input stage 234b in a straight-line shape after the branch off, but has the second power-off point 247b at some points of the third output stage 236c and the fourth output stage 236d after the branch off

In this case, the first conduction pattern terminal 547a and the second conduction pattern terminal 547b may be formed in a front surface of a component (not illustrated) corresponding to the variable switch panel 540 so that the first conduction pattern terminal and the second conduction pattern terminal come into contact with the first power-off point 247a and the second power-off point 247b and have the length ratio of 1:3 as described above. In this case, the component that substitutes the variable switch panel 540 is provided to slide and move on the front surface of the antenna element board 231 in the up and down directions, and thus can implement a phase difference according to the moving distance.

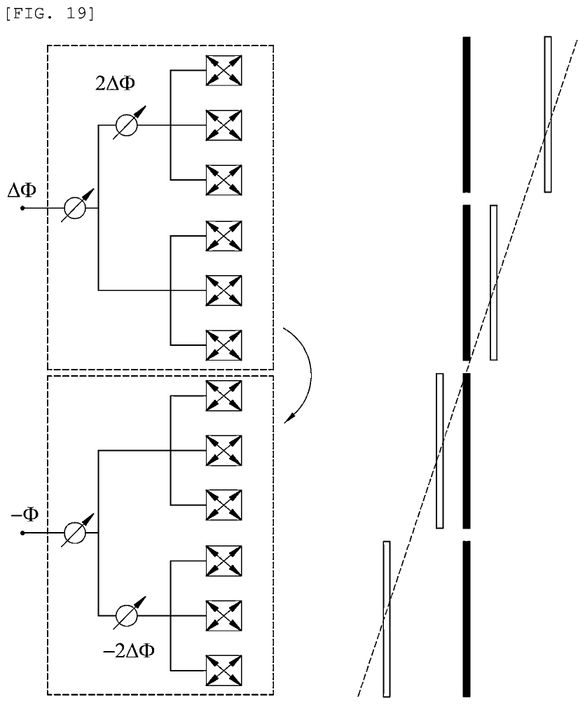

FIG. 19 is a circuit diagram and phase difference diagram for describing the principle of a phase shift form that is performed in the RF stage using the phase shifter of the antenna apparatus according to an embodiment of the present disclosure.

In “Background Art”, the contents in which the phase of a signal that is supplied to at least two of the four array antenna elements 235 requires a support task in the digital stage for the implementation of the mirror symmetry structure although the length of the transmission line is changed in the RF stage have already been described.

However, the full analog phase shifter 500 constructed as described above according to an embodiment of the present disclosure has an advantage in that it does not require a support task in the digital stage, because the one side-transmission line 232a and the other side-transmission line 232b are rotatably provided so that the length of the one side-transmission line and the other side-transmission line is varied at a predetermined ratio by the first conduction pattern terminal 547a and second conduction pattern terminal 547b of the variable switch panel 540 at the first power-off point 247a before a feed signal that is input from one TRx module (means transmission and reception elements mounted on the main board 120 or amplification the element part 220, respectively) is branched off from each input stage to the two output stages and at the second power-off point 247b after the feed signal is branched off, as referred in FIG. 17.

That is, as referred in FIGS. 16 and 19, the first power-off point 247a before being branched off from the first input stage 234a to the first output stage 236a and the third output stage 236c and the first power-off point 247a before being branched off from the second input stage 234b to the second output stage 236b and the fourth output stage 236d implements a desired phase shift value by changing the physical lengths of the one side-transmission line 232a and the other side-transmission line 232b so that the phase is changed by ΔΦ and −ΔΦ by the first conduction pattern terminal 547a of the variable switch panel 540. The second power-off point 247b after being branched off from the first input stage 234a to the third output stage 236c and the second power-off point 247b after being branched off from the third input stage to the fourth output stage 236d may implement a desired phase shift value by changing the physical length of the other side-transmission line 232b so that the phase is changed by 2ΔΦ and −2ΔΦ by the second conduction pattern terminal 547b of the variable switch panel 540.

In this case, a mirror symmetry structure having the most efficient beamforming performance can be implemented because phase shift values for the four array antenna elements 235 can have a linear phase distribution on the basis of the same phase surface.

More specifically, when the two antenna element boards 231 are disposed in parallel in the up and down vertical directions, a first beam output part between the first output stage 236a and the second output stage 236b provided in the antenna element board 231 on the upper side in the vertical direction may be defined, and a second beam output part between the third output stage 236c and the fourth output stage 236d provided in the antenna element board on the upper side in the vertical direction may be defined. Likewise, a third beam output part between the first output stage 236a and the second output stage 236b provided in the antenna element board 231 on the lower side in the vertical direction may be defined, and a fourth beam output part between the third output stage 236c and the fourth output stage 236d provided in the antenna element board on the lower side in the vertical direction may be defined.

In this case, by the simultaneous driving of the two variable switch panels 540, each of the second beam output part and the third beam output part may change the length of the transmission line into the length in which the transmission line is shifted by ±ΔΦ with respect to a same reference phase surface, and each of the first beam output part and the fourth beam output part may changed the length of the transmission line into the length in which the transmission line is shifted by ±Δ3Φ with respect to the same reference phase surface.

To this end, for example, if the two variable switch panels 540 are provided in the rotator type, on the premise that the first power-off point 247a and the second power-off point 247b pattern-printed on the two antenna element boards 231 are the same, it is preferred that the first power-off point and the second power-off point are provided to be rotated in opposite directions.

As described above, the full analog phase shifter 500 and the antenna apparatus 100 including the same according to an embodiment of the present disclosure have advantages in that the first power-off point 247a and the second power-off point 247b can each form a linear phase distribution having a straight-line form through a change in the physical length of the transmission line according to each contact point of the first conduction pattern terminal 547a and the second conduction pattern terminal 547b of the variable switch panel 540 when a signal is input from the TRx module, without an off-set correction (i.e., a support task) for correcting a phase difference in the digital stage, and the mirror symmetry structure capable of the most efficient beamforming performance can be implemented.

The antenna apparatus according to an embodiment of the present disclosure has been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the full analog phase shifter that includes the full analog phase shifter in the RF stage, but does not require a change in the arrangement and design of the existing RF module and can secure a desired phase shift value by selectively changing the lengths of all of the transmission lines without a need for a separate installation space design, and an antenna apparatus including the same.

1. A full analog phase shifter comprising:
a variable switch panel comprising a first conduction pattern terminal and a second conduction pattern terminal; and
an antenna element board in which multiple array antenna elements are disposed and on which a transmission line with which the first conduction pattern terminal and the second conduction pattern terminal come into contact has been pattern-printed, wherein phases for the multiple array antenna elements form a linear distribution on a same reference phase surface by a phase shift at the contact point of the first conduction pattern terminal and the second conduction pattern terminal, and the transmission line.

2. The full analog phase shifter of claim 1, wherein lengths of one side-transmission line and other side-transmission line of the antenna element board have a predetermined ratio.

3. The full analog phase shifter of claim 2, wherein a ratio of lengths of two output stages that come into contact with an inside variable circuit before being branched off from each of two input stages to two output stages and an outside variable circuit after the branch off and that are related to each of the two input stages is the predetermined ratio.

4. The full analog phase shifter of claim 2, wherein the predetermined ratio is 1:3.

5. The full analog phase shifter of claim 3, wherein:
the inside variable circuit and the outside variable circuit are each pattern-printed to have a first power-off point and a second power-off point in each of which a part of the transmission line is disconnected,
a first conduction pattern terminal of the variable switch panel conducts the first power-off point corresponding to the inside variable circuit, and
a second conduction pattern terminal of the variable switch panel conducts the second power-off point corresponding to the outside variable circuit.

6. The full analog phase shifter of claim 5, wherein:
a first output stage and a third output stage that are branched off from a first input stage, among the two input stages, are arranged to be spaced apart from each other in a vertical direction (a V-direction) on a left side of the antenna element board,
a second output stage and a fourth output stage that are branched off from a second input stage, among the two input stages, are arranged to be spaced apart from each other in the vertical direction on a right side of the antenna element board,
on a premise that two antenna element boards are arranged in the vertical direction, two variable switch panels are also provided to be simultaneously driven, and
a vertical phase difference in each output stage by the simultaneous driving of the two variable switch panels has a straight-line gradient distribution with respect to the same reference phase surface.

7. The full analog phase shifter of claim 6, wherein the two variable switch panels are each provided in a rotator type in which the variable switch panel is rotated around a front and rear horizontal axis on a front surface of the inside variable circuit and the outside variable circuit comprising the first power-off point and the second power-off point.

8. The full analog phase shifter of claim 7, wherein the two variable switch panels each having the rotator type are provided to rotate in opposite directions, on a premise that the first power-off point and the second power-off point pattern-printed on the two antenna element boards are identical with each other.

9. The full analog phase shifter of claim 6, wherein the two variable switch panels are each provided in a slider type in which the variable switch panel slides in the vertical direction on a front surface of the first power-off point and the second power-off point.

10. The full analog phase shifter of claim 9, wherein the two variable switch panels each having the slider type are provided to simultaneously slide in an identical direction, on a premise that all of transmission lines comprising the first power-off point and the second power-off point that are pattern-printed on the two antenna element boards are symmetrical to each other.

11. The full analog phase shifter of claim 6, wherein when a first beam output part between the first output stage and the second output stage that are provided in an antenna element board on an upper side in the vertical direction, among the two antenna element boards, is defined and a second beam output part between the third output stage and the fourth output stage that are provided in the antenna element board on the upper side is defined, and a third beam output part between the first output stage and the second output stage that are provided on an antenna element board on a lower side in the vertical direction, among the two antenna element boards, is defined and a fourth beam output part between the third output stage and the fourth output stage that are provided on the antenna element board on the lower side is defined,
by the simultaneous driving of the two variable switch panels, each of the second beam output part and the third beam output part changes a length of the transmission line into a length in which the transmission line is shifted by ±ΔΦ with respect to the same reference phase surface, and each of the first beam output part and the fourth beam output part changes the length of the transmission line into a length in which the transmission line is shifted by ±Δ3Φ with respect to the same reference phase surface.

12. An antenna apparatus comprising:
a unit RF filter body configured to form a predetermined front and rear thickness part on a front surface of a main board, stacked and arranged to be electrically connected to the main board, and configured to have, on a front surface thereof, a reflector panel that performs a ground (GND) function integrally extended and formed in up and down and left and right directions in an area greater than an area of the front surface;
a radiation element module stacked and disposed on the front surface of the reflector panel and comprising, on a front surface thereof, an antenna element board in which four array antenna elements are disposed to be spaced apart from each other in the up and down directions; and
a full analog phase shifter (hereinafter abbreviated as a “phase shifter”) comprising multiple variable switch panels that change a length of a transmission line by an operation of rotating in a separation space formed between the four array antenna elements and the antenna element board.

13. The antenna apparatus of claim 12, wherein the separation space is defined between a rear surface of the four array antenna elements and a front surface of the antenna element board.

14. The antenna apparatus of claim 12, wherein the phase shifter further comprises:
a phase shift driving motor disposed in the front and rear thickness part of the unit RF filter body on a rear side of the antenna element board;
a horizontal mounting bar moved in the up and down directions by a driving force of the phase shift driving motor; and
multiple vertical mounting bars each having one end connected to the horizontal mounting bar and the other end vertically extended upward or downward and connected to each of the multiple variable switch panels.

15. The antenna apparatus of claim 14, wherein a hinge coupling hole that is hinged and coupled to a hinge coupling protrusion formed on a front surface of the horizontal mounting bar is formed at any one, among one end and the other end of the vertical mounting bar.

16. The antenna apparatus of claim 14, wherein a hinge pin hinged and coupled to the variable switch panel through the reflector panel formed to be wider than a front surface of the unit RF filter body and the antenna element board is formed at the other one, among one end and the other end of the vertical mounting bar.

17. The antenna apparatus of claim 16, wherein an arc type guide slot that provides guidance to an arc movement of the hinge pin of the vertical mounting bar is formed in the reflector panel and the antenna element board so that the guide slot penetrates the reflector panel and the antenna element board in forward and backward directions.

18. The antenna apparatus of claim 14, wherein:
a screw rod having a male screw thread formed on an outer circumferential surface thereof and extended in a predetermined length in a direction of a rotation axis of the phase shift driving motor is provided in the rotation axis, and
the phase shifter further comprises:
an up and down moving block in which a rod through part through which the screw rod penetrates in the up and down directions is formed and an arm screw thread fastened to the male screw thread is formed in the rod through part, and which are moved in the up and down directions in response to a rotation direction of the screw rod; and
a block guide part configured to provide guidance to the up and down movement of the up and down moving block.

19. The antenna apparatus of claim 18, wherein the horizontal mounting bar is hook-coupled to a front of the up and down moving block.

20. The antenna apparatus of claim 19, wherein the phase shifter further comprises a horizontal bracket part left and right horizontally disposed within an antenna housing part in which a main board is installed so that the block guide part is fixed,
wherein bearing wheels rotatably supported within a left support panel and a right support panel provided at both ends of the horizontal bracket part are provided at both ends of the horizontal mounting bar, respectively.

21. The antenna apparatus of claim 20, further comprising at least one fixing bridge bar for fixing the unit RF filter body to an internal space of the antenna housing part,
wherein the horizontal bracket part is fixed to the internal space of the antenna housing part in order to substitute any one of the fixing bridge bars.

22. The antenna apparatus of claim 20, further comprising at least one fixing bridge bar for fixing the unit RF filter body to an internal space of the antenna housing part,
wherein the horizontal bracket part is fixed to the internal space of the antenna housing part through a medium of any one of the fixing bridge bars.

23. The antenna apparatus of claim 21, wherein:
the fixing bridge bar is left and right horizontally extended and formed in each of a top portion, bottom portion, and middle portion of the internal space of the antenna housing part, and
the horizontal bracket part substitutes a fixing bridge bar formed in the middle portion.

24. The antenna apparatus of claim 22, wherein:
the fixing bridge bar is left and right horizontally extended and formed in each of a top portion, bottom portion, and middle portion of the internal space of the antenna housing part, and
the horizontal bracket part is fixed through the medium of the fixing bridge bar formed in the middle portion.

25. The antenna apparatus of claim 23, wherein assuming that two unit RF filter bodies are arranged in the internal space of the antenna housing part in up and down vertical directions (V-direction), the horizontal bracket part that substitutes the fixing bridge bar constructed in the middle portion is provided in a space between the two unit RF filter bodies in the up and down directions.

26. The antenna apparatus of claim 21, wherein multiple screw fastening holes for a screw assembly with the unit RF filter body are formed in the fixing bridge bar or the horizontal bracket part that substitutes the fixing bridge bar.

27. The antenna apparatus of claim 14, wherein the vertical mounting bar is provided to correspond to a number of unit RF filter bodies.

28. An antenna apparatus comprising the full analog phase shifter of claim 1.
